(19) United States
(12) Patent Application Publication
(10) Pub. No.: US 2025/0307837 A1
(43) Pub. Date: Oct. 2, 2025

(54) SYSTEMS AND METHODS FOR AUTOMATED CUSTOMER CARE

(71) Applicant: Sprinklr, Inc., New York, NY (US)

(72) Inventors: Yogin Patel, Gandhinagar (IN); Anand Kumar Singh, Pune (IN); Ayub Subhaniya, Jamnagar (IN); Koushik Konwar, Charaideo (IN); Raghav Garg, Ghaziabad (IN); Naman Mohont, Jodhpur (IN); Ratnesh Jamidar, Jhalawar (IN)

(21) Appl. No.: 19/092,885

(22) Filed: Mar. 27, 2025

Related U.S. Application Data
(60) Provisional application No. 63/571,071, filed on Mar. 28, 2024.

(51) Int. Cl. G06Q 30/015; G06Q 10/0631

(52) U.S. Cl. CPC G06Q 30/015; G06Q 10/06316

(57) ABSTRACT

Systems and methods applicable, for instance, to automated customer care. Machine learning approaches can be used to generate playbooks from conversations. Also, machine learning approaches can be used to coordinate playbook use. Further, machine learning approaches can be used to manage agent quality.

### CROSS-REFERENCE TO RELATED APPLICATIONS

This application claims priority to U.S. Provisional Patent Application Ser. No. 63/571,071, filed on Mar. 28, 2024, the contents of which are incorporated herein by reference in their entirety and for all purposes.

### FIELD OF THE INVENTION

The present technology relates to the field of customer care, and more specifically, but not exclusively, to techniques for using machine learning models to automate customer care.

### BACKGROUND OF THE INVENTION

Conventional customer care workflow solutions are typically driven by complex workflows and rigid protocols, requiring significant back-end setup time and hindering maintainability and natural interaction. Moreover, conventional artificial intelligence AI chatbot systems tend to struggle to comprehensively cover diverse customer care situations. As just one example, these conventional AI chatbot systems can fail to deliver various responses due to their finite, pre-defined conversation trees. According to conventional approaches, such as those using heavily scripted systems, maintaining aspects including quality management, customer satisfaction, and scalability can be challenging. Accordingly, difficulties including but not limited to an inability to adapt and evolve based on customer needs can arise.

Existing approaches include platforms such as Google Dialogflow. Dialogflow supports intent-driven flow chart or tree-based scripted conversation models. The rigid structure of Dialogflow provides unsatisfactory results. For instance, such rigid structure hampers natural language interactions, and tends to be hard to update and maintain.

Further, conventional approaches fail to provide unified solutions that solve, for instance, additional problems of customer care AI (CCAI) such as workflow (or playbook) discovery and/or generation, quality management, and/or chatbot and/or conversation analytics. In the space of quality management, conventional approaches are often limited to testing agent tone, empathy, or linguistic sanity (e.g., of spelling and/or grammar). These conventional approaches lack at least a holistic review of conversations, and further significantly lack flexibility in evaluating agent quality (e.g., based on a brand's specific criteria and/or requirements). Moreover, there is no conventional approach that achieves workflow (or playbook) discovery and/or generation from conversations. For example, there is no conventional approach that looks at an entire conversation and lets brands decide their agenda of evaluation in form of natural language.

In view of at least the foregoing, a need exists for improved systems and methods for automated customer care, in an effort to overcome the aforementioned obstacles and deficiencies of conventional approaches.

### BRIEF DESCRIPTION OF THE DRAWINGS

FIG. 1 is a diagram depicting an example scenario, according to various embodiments.

FIG. 2 is text depicting an example playbook template, according to various embodiments.

FIG. 3 is a diagram depicting an example approach for playbook generation, according to various embodiments.

FIG. 4 is a graphic depicting example discovered conversation clusters, according to various embodiments.

FIG. 5 is a graphic depicting example conversation issue subclusters, according to various embodiments.

FIG. 6 is a diagram depicting an example of vector database use, according to various embodiments.

FIG. 7 is a plot depicting example clusters to which conversations have been mapped, according to various embodiments.

FIG. 8 is a diagram depicting an example approach for nudge generation, according to various embodiments.

FIG. 9 is text depicting example conversation nudges, according to various embodiments.

FIG. 10 shows an example computer, according to various embodiments.

### DETAILED DESCRIPTION

A playbook can provide a set of guidelines that direct agents (e.g., chatbot agents and human agents) on how to respond in a variety of customer interactions. As just an example, such playbooks can be used to automate customer care (e.g., an end-to-end Customer Experience Management (CXM) ecosystem).

According to a first aspect, machine learning approaches can be used to generate such playbooks from conversations (e.g., customer care case conversations) between agents and customers. According to a second aspect, machine learning approaches can be used to coordinate (e.g., in real-time) the employ of different playbooks during a conversation. According to a third aspect, machine learning approaches can be used to manage agent (e.g., chatbot agent and human agent) quality. In this way, various benefits including providing solutions to the limitations of existing AI chat bots can accrue.

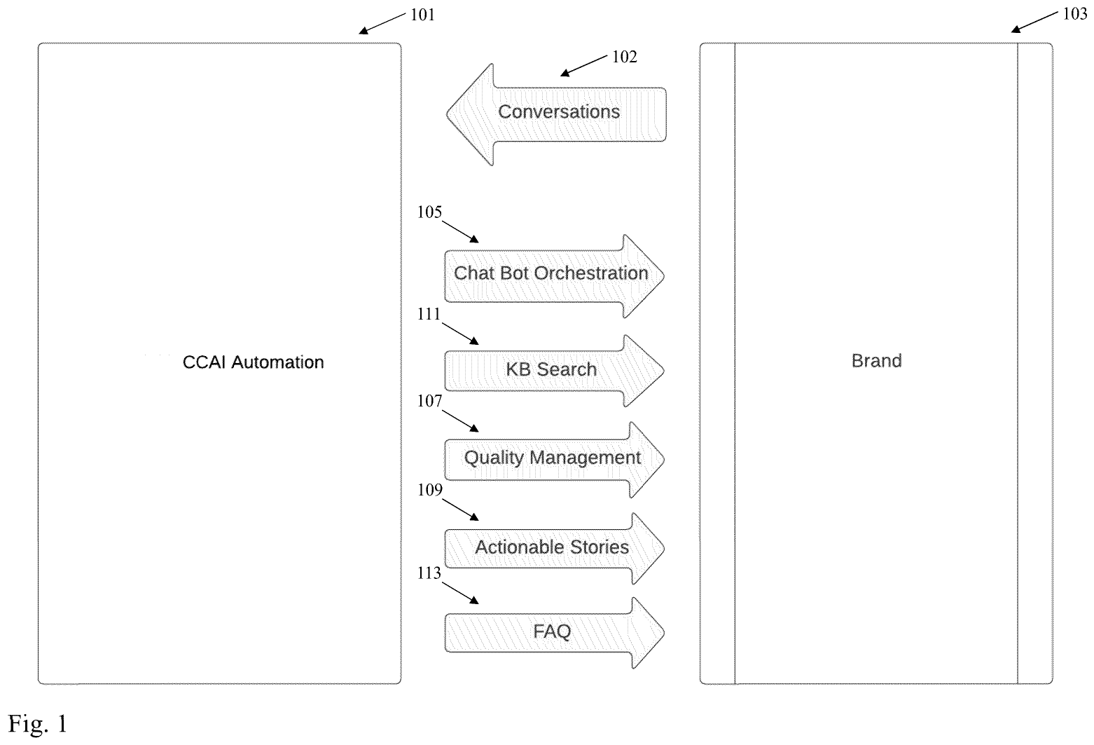

Turning to FIG. 1, an example scenario is shown wherein the functionality discussed herein 101 (labeled “CCAI Automation” in the figure, where CCAI refers to customer care artificial intelligence) can receive (e.g., as textual data) conversations 102 of the sort noted from a brand 103. Using the received conversations, the functionality discussed herein can perform various operations. For example, using the received conversations the functionality discussed herein can perform the noted coordination of using different playbooks during a conversation 105 (labeled “chat bot orchestration” in the figure). As another example, using the received conversations the functionality discussed herein can perform the noted management of agent quality (e.g., generating actionable nudges) 107 (labeled “quality management” in the figure). As an additional example, using the received conversations the functionality discussed herein can perform the noted playbook generation (not shown). As yet another example, using the received conversations the functionality discussed herein can generate stories 109 (labeled “actionable stories” in the figure). These four capabilities are discussed in greater detail hereinbelow. Then, as further examples, using the received conversations the functionality discussed herein can generate knowledge base (KB) entries 111 (labeled “KB search” in the figure) and generate frequently asked questions (FAQs) 113.

According to the KB entry generation functionality, the CCAI automation can utilize a large language model (LLM) that receives conversations of the sort noted, and that outputs KB entries based on those conversations. The LLM (e.g., a decoder transformer-based LLM) can have been pretrained on a guess-the-next-token task with respect to a corpus. Subsequently the LLM can have been fine-tuned using a training set of labeled examples, in particular conversations of the sort noted and corresponding KB entries based on those conversations. According to the FAQ generation functionality, the CCAI automation can utilize machine learning question and answer generator approaches (e.g., transformer encoder/decoder-based approaches) so as to receive conversations of the sort noted, and output questions and corresponding answers based on those conversations.

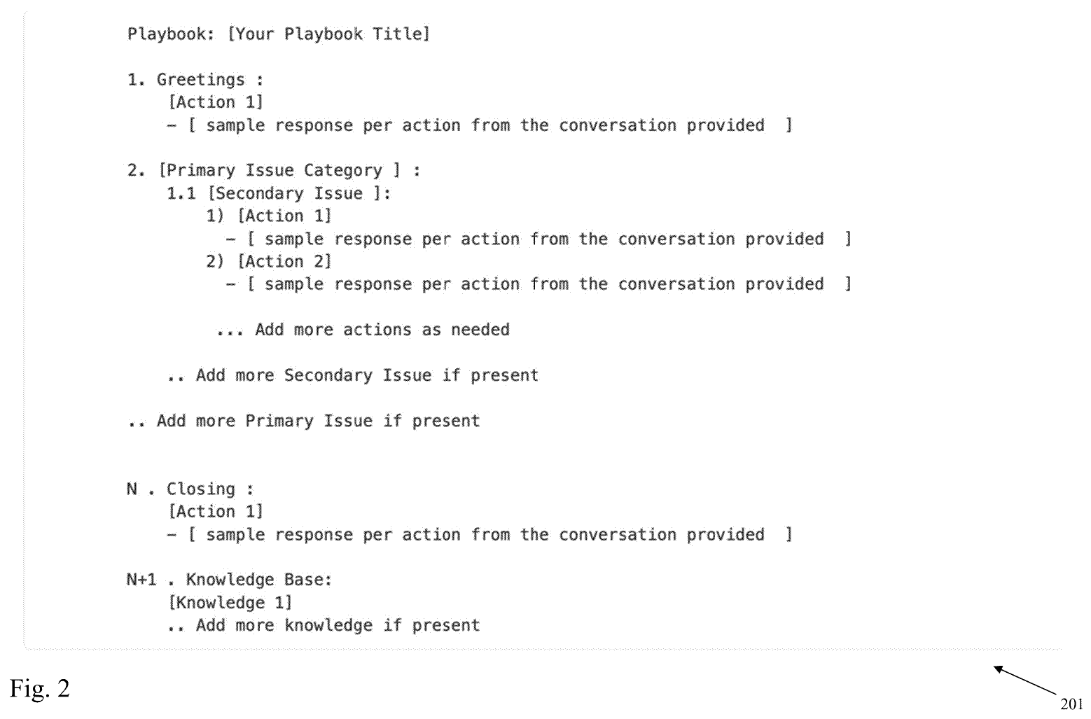

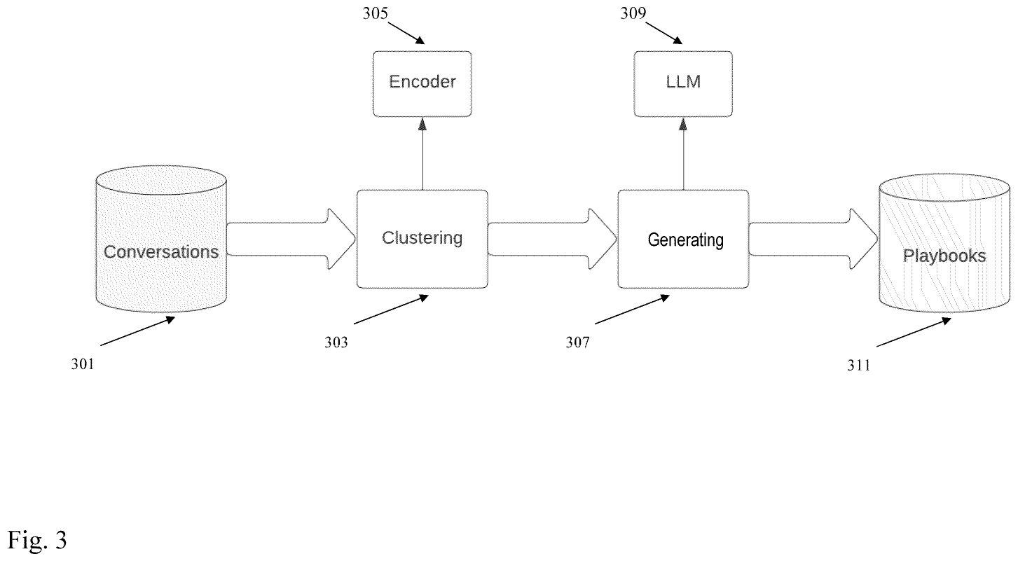

Shown in FIG. 2 is an example playbook template 201. According to the playbook generation functionality discussed herein, machine learning approaches can be used to generate, from conversations between agents and customers, playbooks matching this template. Then, shown in FIG. 3 is an example diagram depicting an approach for playbook generation. According to the example of FIG. 3, conversations of the sort noted 301 can be provided as input to machine learning model (MLM) 303. The MLM 303 can perform clustering (e.g., transformer encoder-based clustering 305) on the conversations. The clustering performed by the MLM 303 can serve to map inputted conversations such that similar conversations are mapped to similar locations in space. In this way, the MLM can perform discovery with respect to conversations to get distinct clusters of conversations. This approach for the discovery of playbook clusters can be viewed as an unsupervised approach. Although the MLM 303 is discussed as performing transformer encoder-based clustering, other possibilities exist. For example, the MLM 303 can employ a classical machine learning clustering approach.

Further according to the example of FIG. 3, an MLM 307 can take as input one or more conversations, and generate as output a playbook based on those conversations. In particular, the one or more conversations can correspond to the conversations of a given cluster according to the clustering performed by the MLM 303, and the generated playbook can reflect the conversations of that cluster. The MLM 307 can be implemented as an LLM 309 (e.g., a decoder transformer-based LLM). The LLM 307 can have been pretrained on a guess-the-next-token task with respect to a corpus and can subsequently have been fine-tuned using a training set of labeled examples. More specifically, a given member of the training set can include (as training inputs) one or more conversations, and (as training outputs) a corresponding playbook based on those conversations. As just some examples, such a playbook can enforce the agenda of evaluation of a given brand (e.g., expressed as natural language), can enforce alignment with goals of brand leadership and/or agent managers, and/or can ensure satisfactory customer care conversations. In this way, the MLM 307 can generate playbooks 311 for one or more of the conversation clusters generated by MLM 303. The system can, in various embodiments, maintain record (e.g., via a lookup table or vector database) of the conversation cluster to which a given generated playbook corresponds. Where, for instance, a lookup table is used, UUIDs can be employed to identify clusters and to identify generated playbooks. Moreover, in various embodiments the system can store the generated playbooks in a vector database in embedding form.

The discussed operations can yield various benefits. For example, the discussed operations can take into account entire conversations (e.g., historic customer care conversations), as opposed to, say, being limited to taking into account fan messages (e.g., as posted on social networks). As another example, according to the discussed operations playbooks can be generated (e.g., generated for a given cluster) using the discussed MLMs as opposed to, say, there being call for software engineer analytical effort in comprehending and/or building a workflow. As a further example, according to the discussed operations playbooks can be generated without call for dialog trees. As such, for instance, having a software engineer build a dialog tree from manual recall can be avoided.

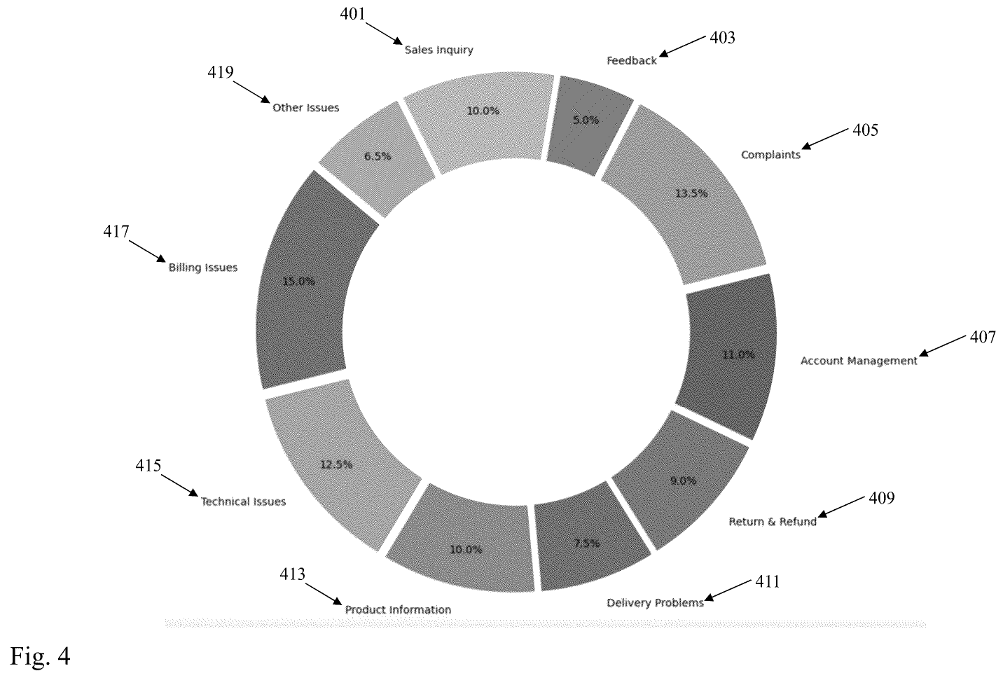

The unsupervised clustering performed by the MLM 303 can yield benefits including achieving high coverage of issues allowing, for instance, for the development of downstream products that handle these issues. Shown in FIG. 4 is an example graphic depicting illustrative conversation clusters discovered by the action of MLM 303. As referenced, playbooks can, by the action of MLM 307, subsequently be generated for these conversation clusters. As shown by FIG. 4, a wide range of issues can be discovered by the action of MLM 303. According to the example of FIG. 4, these issues can include: a) sales inquiries 401; b) feedback 403; c) complaints 405; d) account management 407; e) return and refund 409; f) delivery problems 411; g) product information 413; h) technical issues 415; i) billing issues 417; and j) other issues 419.

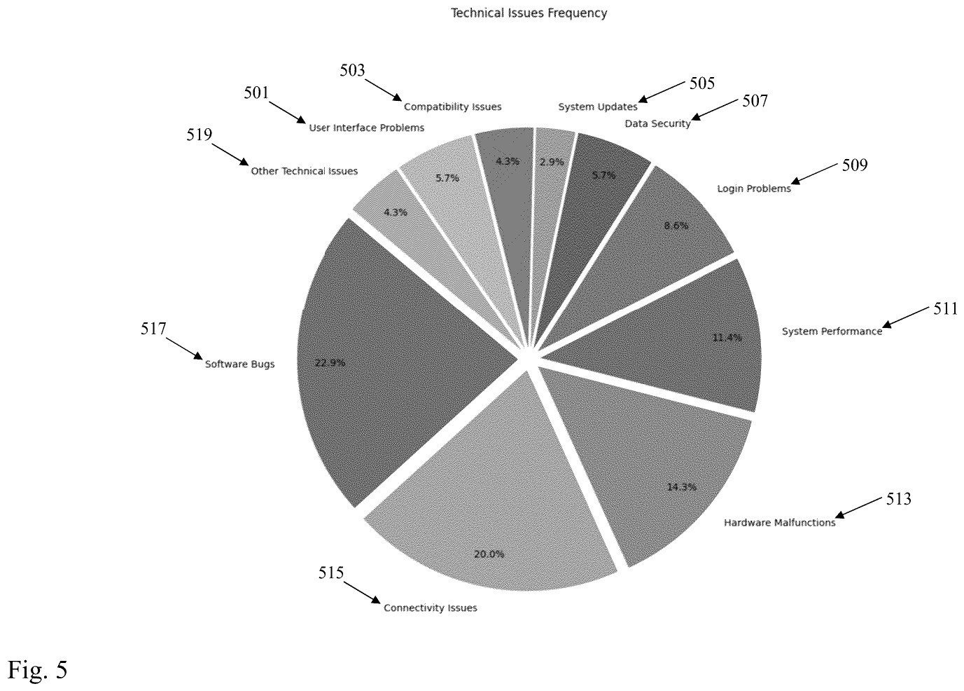

According to various embodiments, the conversation clusters generated by the MLM 303 can be viewed as being clusters that include subclusters. Accordingly, FIG. 5 is an example graphic depicting illustrative conversation issue subclusters of the “technical issues” cluster of FIG. 4. According to the example of FIG. 5, these subcluster issues can include: a) user interface problems 501; b) compatibility issues 503; c) system updates 505; d) data security 507; e) login problems 509; f) system performance 511; g) hardware malfunctions 513; h) connectivity issues 515; i) software bugs 517; and j) other technical issues 519. It is observed that the conversation clusters and subclusters generated by the action of MLM 303 can yield various benefits over manually mining and configuration. As just one example, the clusters and subclusters generated by the action of MLM 303 can surpass human-generated results in terms of precision and coverage. As an example benefit of the discussed operations, playbooks can be based on clusters or subclusters, thereby being reflective of the conversational content of those clusters or subclusters. In this way, the generation can beneficially yield playbooks that meet the needs of various customer care scenarios.

With further regard to the employment of different playbooks during a conversation, the following is noted. As referenced above, according to various embodiments, during the generation of playbooks 311 the system can maintain record of the conversation cluster to which a given generated playbook corresponds. This record can be considered a playbook index. As an example, in these embodiments during a new conversation (e.g., between a customer and a chatbot or human agent), the record can be accessed in order to determine a playbook that has been generated for conversations of a cluster to which the new conversation has been mapped by MLM 303 (e.g., where the record is a lookup table), or to which the new conversation is mappable (e.g., where the record is a vector DB). The determined playbook can be used as the playbook for the new conversation. As also referenced above, according to various embodiments the system can store generated playbooks in a vector database in embedding form. Such storage can also be considered a playbook index. As a further example, in these embodiments a new conversation can be used to access the vector database in order to determine a playbook that is similar to the new conversation. The determined playbook can be used as the playbook for the new conversation.

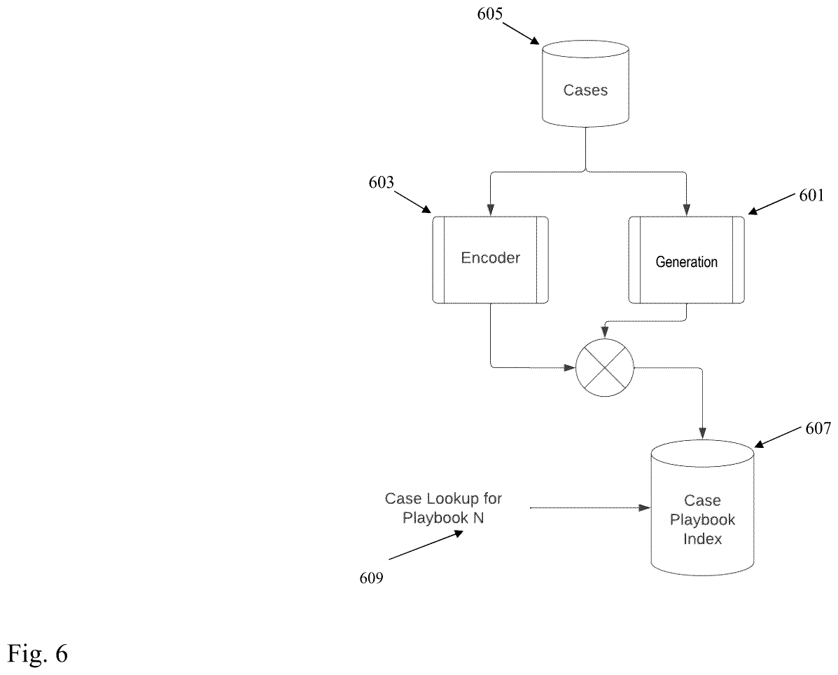

Turning to FIG. 6, shown is an example of the use of a vector database. When generating playbooks as discussed (601), the system can use encoder 603 to generate embeddings for conversations 605 (labeled “cases” in the figure). In this way, a given generated playbook can be stored in the vector database 607 (labeled “case playbook index” in the figure) in correlation with the embeddings of those conversations for which the playbook was generated. Where a new conversation is at hand, the encoder 603 can be used to generate an embedding for the new conversation. Subsequently the embedding for the new conversation can be used to access (609) the vector database 607 in order to determine a playbook that has been generated for conversations of a cluster to which the new conversation is mappable.

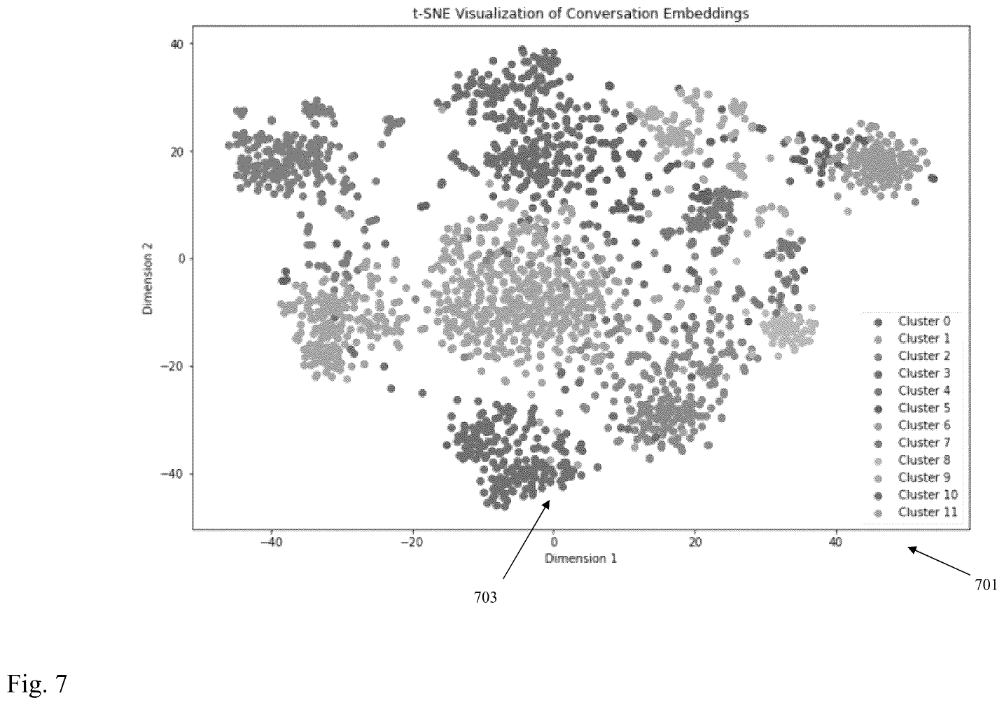

Turning to FIG. 7, shown is an example of various clusters 701 to which the MLM 303 can have mapped conversations during the generation of playbooks 311. As referenced, the system can have maintained record of the playbook that has been generated for a given cluster. As such, according to the example of FIG. 6 the system can have record of the playbook that has been generated for each of the twelve depicted clusters. As just an illustration, the MLM 303 can map a new conversation to cluster 3 (703). Further according to the illustration, the system can consult the noted record (e.g., a lookup table) to determine the playbook that has been generated for cluster 3. Subsequently, the playbook for cluster 3 can be used as the playbook for the new conversation.

It is observed that the noted functionality can be performed multiple times during a conversation. In this way the playbook employed by the conversation can change over the course of the conversation (e.g., in real-time). As such, various benefits can accrue, including ensuring that appropriate playbooks are employed at different points in a conversation, despite changes that can occur in the tenor of the conversation. Also, the system can maintain record (e.g., via a lookup table or vector database) of the one or more playbooks that are used for a given new conversation.

With further regard to management of agent quality, the following is noted. In an aspect, there can be use of a MLM that receives as input both one or more conversations of the sort noted and one or more playbooks, and that outputs various quality metrics regarding how well the one or more conversations adhere to the playbook(s). As one example, the playbook(s) provided as input to the MLM can be the playbook(s) that were used as reference for the one or more conversations (e.g., as indicated by the above-noted record of those playbook(s) that are used for given conversations). As another example, the playbook(s) provided as input to the MLM can be one or more playbooks that the system determines to be appropriate for the one or more conversations.

The MLM can be an LLM (e.g., a decoder transformer-based LLM) that has been pretrained as discussed above, and that has subsequently been fine-tuned using a training set of labeled examples. A given member of the training set can include, as training inputs both, one or more conversations of the sort noted and one or more playbooks. Further, the given member of the training set can include, as training output, one or more quality metrics regarding how well the one or more conversations adhere to the playbook(s).

As just an example, the quality metrics generated by the MLM can indicate an ability of an agent (e.g., a chatbot or human agent) to stay within the guidelines provided by one or more given playbooks while, say, simultaneously maintaining a flexible and natural conversation. As just another example, the quality metrics generated by the MLM can include predictive customer satisfaction (CSAT) metrics. In various embodiments the system can perform timeseries analysis of various quality metrics generated by the MLM (e.g., CSAT). In this way, the system can provide functionality including anomaly and event detection.

The quality metrics generated by the MLM can be used for a variety of purposes. As one example, the generated quality metrics can provide actionable insights to agent managers who are looking to improve agent performance. As another example, the generated quality metrics can be used to formulate conversation nudges. These conversation nudges can, for instance, provide advice for conversation improvement. Where the agent is a human agent, the advice can be provided to the human agent via a UI (e.g., a chat window displaying an at-hand conversation between the human agent and a customer). Where the agent is a chatbot, the advice can be provided to a human agent manager (e.g., allowing the manager to intervene in a conversation in view of the advice). The nudges discussed herein can be referred to as AI nudges.

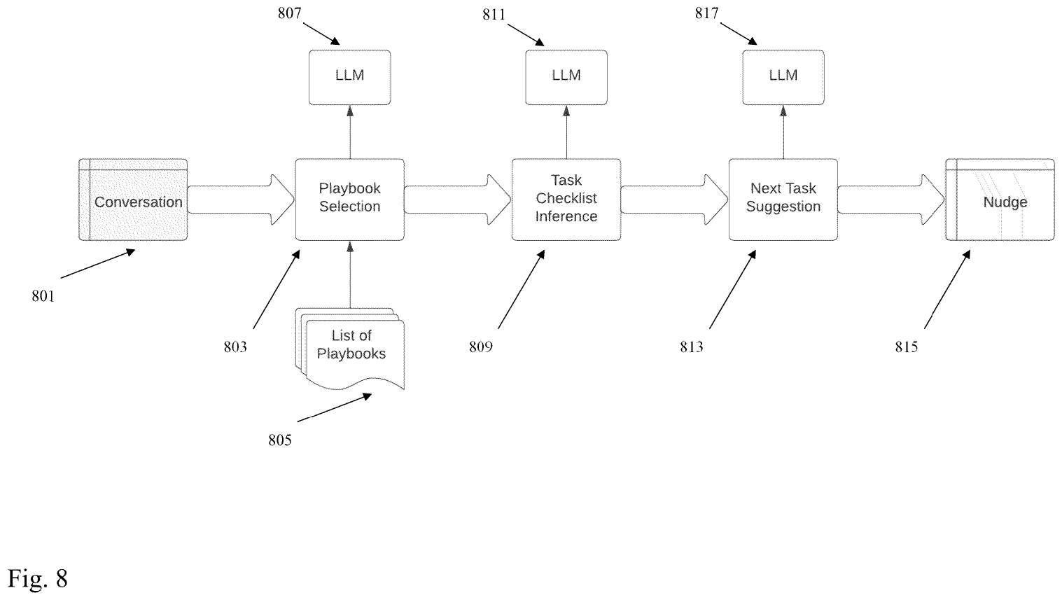

Turning to FIG. 8, the system can access one or more conversations 801 of the sort noted. Further, the system can select (803) from playbooks 805 one or more playbooks to be considered in relation to the conversations 801. As an example, as referenced above the selection 803 can include the system ascertaining the playbook(s) that were used as reference during the one or more conversations 801 (e.g., the system can access the above-noted record).

Such playbook(s) can be selected by the system as those to be considered in relation to the conversations 801. As another example, the selection 803 can include the system determining one or more playbooks to be appropriate for the one or more conversations 801. Such playbooks can be selected by the system as those to be considered in relation to the conversations 801.

As one alternative for such determination of appropriate playbooks, the system can use the MLM 303 to map given ones of the conversations 801 to a cluster to which previous conversations have been mapped (e.g., in connection with playbook generation as discussed above). Such mapping by the MLM 303 can utilize transformer encoder-based clustering. The system can subsequently consult the noted record in order to determine the particular playbook that has been previously generated by MLM 307 (depicted as LLM 807 in the figure) for the cluster to which a given one of the conversations 801 has been mapped. Subsequently the determined playbooks can be selected by the system as those to be considered in relation to the conversations 801. As another alternative for the determination of appropriate playbooks, for a given one of the conversations 801 the system can access the above-discussed vector database with respect to that conversation in order to determine a playbook that is similar to the conversation. Such playbooks can be selected by the system as those to be considered in relation to the conversations 801. It is noted that, in various embodiments, the functionality of playbook selection 803 can include the system receiving an indication of one or more playbooks, such as from a manager user. As just an example, such provided playbooks can enforce the specific criteria and/or requirements of a given brand.

With further reference to FIG. 8, the system can perform task checklist inference operations 809. The task checklist inference operations 809 can use a MLM that receives as input both one or more conversations of the sort noted, and the one or more playbooks yielded by selection 803. The MLM of task checklist inference operations 809 can generate as output one or more tasks that have been accomplished and/or overlooked in view of the playbooks.

The MLM of task checklist inference operations 809 can be an LLM 811 (e.g., a decoder transformer-based LLM) that has been pretrained as discussed above, and that has subsequently been fine-tuned using a training set of labeled examples. A given member of the training set can include, as training inputs both the one or more conversations and one or more playbooks. Further, the given member of the training set can include, as training output, one or more tasks that, in view of the playbooks, have been accomplished and/or overlooked.

Also with reference to FIG. 8, the system can perform next task suggestion operations 813. The next task suggestion operations 813 can use a MLM that receives as input both one or more conversations of the sort noted, and the output that the MLM discussed in connection with task checklist inference operations 809 has generated for those conversations (i.e., one or more tasks that have been accomplished and/or overlooked). The MLM of next task suggestion operations 813 can generate as output one or more next task suggestions (e.g., in the form of nudges 815).

The MLM of next task suggestion operations 813 can be an LLM 817 (e.g., a decoder transformer-based LLM) that has been pretrained as discussed above, and that has subsequently been fine-tuned using a training set of labeled examples. A given member of the training set can include, as training inputs both one or more conversations and one or more tasks that have been accomplished and/or overlooked. Further, the given member of the training set can include, as training output, one or more next task suggestions (e.g., nudges). It is noted that, in various embodiments, the functionality of operations 813 can include the generation of suggestions in the form of stories (e.g., timewise presentations of various events in a given conversation, along with indications of praise and/or constructive criticism for those events).

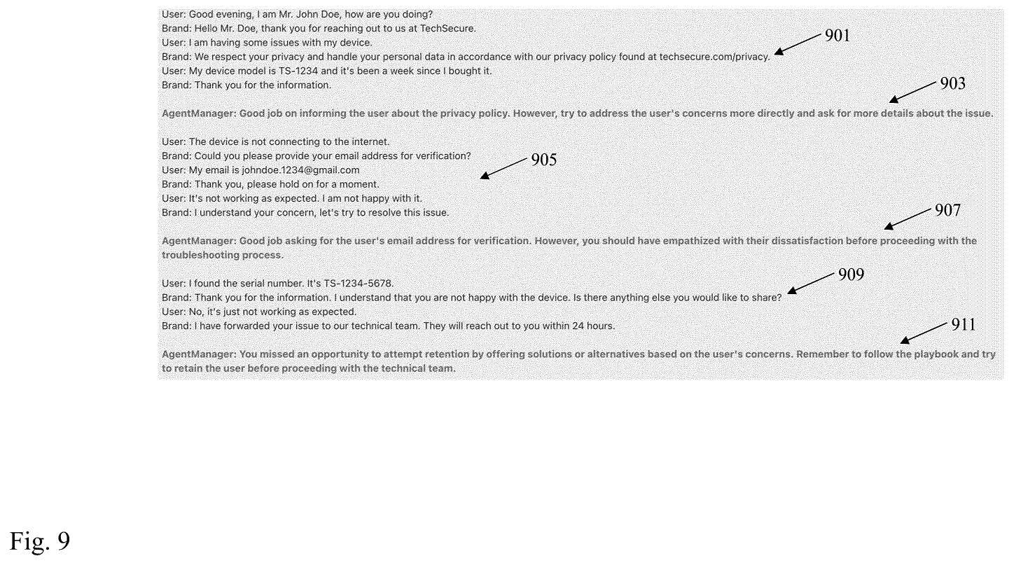

Shown in FIG. 9 are example nudges 901, 905 and 909 for conversations 903, 907, and 911. Where an at-hand agent is a human agent, the nudges 901, 905 and 909 can be provided to the human agent via a UI. Where an at-hand agent is a chatbot, the nudges 901, 905 and 909 can, as just one example, be provided to a human agent manager, thereby allowing the manager to intervene in the corresponding conversation in view of the advice.

According to the functionality discussed herein, various benefits can accrue. For example, the approaches discussed herein provide for generalization in terms of implementing AI chatbot functionality (e.g., via the above-discussed playbook generation). In contrast, according to conventional approaches building a new use case for an AI chat bot is typically difficult. As another example, the approaches discussed herein provide for ease of maintainability. In contrast, according to conventional approaches changing AI chat bot workflows is typically a troublesome affair.

As yet another example, the approaches discussed herein provide for increased flexibility. In contrast, according to conventional approaches AI chatbots typically generate very limited responses. As an additional example, the approaches discussed herein provide for wide coverage. In contrast, according to conventional approaches various customer use cases (e.g., for chatbot interaction) lack coverage. As a further example, the approaches discussed herein provide for various forms of advanced use of natural language (e.g., in interactions between customers and chatbots). In contrast, according to conventional approaches rigid protocols typically hamper, for instance, the natural flow of conversations, and inhibit understanding between agents and customers.

As a further example benefit, the approaches discussed herein can yield an automated CCAI ecosystem that can use a playbook as a centralized entity. As yet another example benefit, the approaches discussed herein can yield chatbots that cover all (or nearly all) possible issues within conversations that are provided to the discussed MLM. Moreover, the aforementioned can be achieved in one step (or in a small number of steps), with little or no human intervention. More generally, as an additional example benefit, according to the approaches discussed herein with merely (or with little more than) a playbook, CCAI workflows can be automated and/or made more efficient.

### Hardware and Software

According to various embodiments, various functionality discussed herein can be performed by and/or with the help of one or more computers. Such a computer can be and/or incorporate, as just some examples, a personal computer, a server, a smartphone, a system-on-a-chip, and/or a microcontroller. Such a computer can, in various embodiments, run Linux, MacOS, Windows, or another operating system.

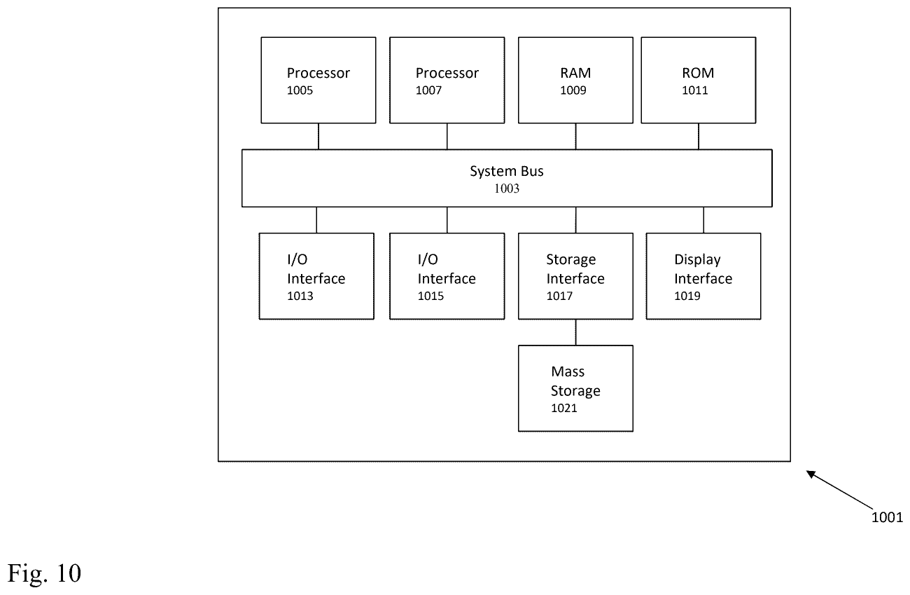

Such a computer can also be and/or incorporate one or more processors operatively connected to one or more memory or storage units, wherein the memory or storage may contain data, algorithms, and/or program code, and the processor or processors may execute the program code and/or manipulate the program code, data, and/or algorithms. Shown in FIG. 10 is an example computer employable in various embodiments of the present invention. Example computer 1001 includes system bus 1003 that operatively connects two processors 1005 and 1007, random access memory (RAM) 1009, read-only memory (ROM) 1011, input output (I/O) interfaces 1013 and 1015, storage interface 1017, and display interface 1019. Storage interface 1017 in turn connects to mass storage 1021. Each of I/O interfaces 1013 and 1015 can, as just some examples, be a Universal Serial Bus (USB), a Thunderbolt, an Ethernet, a Bluetooth, a Long-Term Evolution (LTE), a 5G, an IEEE 488, and/or other interface. Mass storage 1021 can be a flash drive, a hard drive, an optical drive, or a memory chip, as just some possibilities. Processors 1005 and 1007 can each be, as just some examples, a commonly known processor such as an ARM-based or x86-based processor. Computer 1001 can, in various embodiments, include or be connected to a touch screen, a mouse, and/or a keyboard. Computer 1001 can additionally include or be attached to card readers, DVD drives, floppy disk drives, hard drives, memory cards, ROM, and/or the like whereby media containing program code (e.g., for performing various operations and/or the like described herein) can be inserted for the purpose of loading the code onto the computer.

In accordance with various embodiments of the present invention, a computer may run one or more software modules designed to perform one or more of the above-described operations. Such modules can, for example, be programmed using Python, Java, JavaScript, Swift, C, C++, C#, and/or another language. Corresponding program code can be placed on media such as, for example, DVD, CD-ROM, memory card, and/or floppy disk. It is noted that any indicated division of operations among particular software modules is for purposes of illustration, and that alternate divisions of operation may be employed. Accordingly, any operations indicated as being performed by one software module can instead be performed by a plurality of software modules. Similarly, any operations indicated as being performed by a plurality of modules can instead be performed by a single module. It is noted that operations indicated as being performed by a particular computer can instead be performed by a plurality of computers. It is further noted that, in various embodiments, peer-to-peer and/or grid computing techniques may be employed. It is additionally noted that, in various embodiments, remote communication among software modules may occur. Such remote communication can, for example, involve JavaScript Object Notation-Remote Procedure Call (JSON-RPC), Simple Object Access Protocol (SOAP), Java Messaging Service (JMS), Remote Method Invocation (RMI), Remote Procedure Call (RPC), sockets, and/or pipes.

Moreover, in various embodiments the functionality discussed herein can be implemented using special-purpose circuitry, such as via one or more integrated circuits, Application Specific Integrated Circuits (ASICs), or Field Programmable Gate Arrays (FPGAs). A Hardware Description Language (HDL) can, in various embodiments, be employed in instantiating the functionality discussed herein. Such an HDL can, as just some examples, be Verilog or Very High Speed Integrated Circuit Hardware Description Language (VHDL). More generally, various embodiments can be implemented using hardwired circuitry without or without software instructions. As such, the functionality discussed herein is limited neither to any specific combination of hardware circuitry and software, nor to any particular source for the instructions executed by the data processing system.

### RAMIFICATIONS AND SCOPE

Although the description above contains many specifics, these are merely provided to illustrate the invention and should not be construed as limitations of the invention's scope. Thus, it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

1. A computer-implemented method, comprising:
providing, by a computing system, to a first machine learning model, one or more customer care conversations;
mapping, by the computing system using the first machine learning model, the one or more customer care conversations to one or more clusters;
providing, by the computing system, to a second machine learning model, said one or more clustered customer care conversations; and
generating, by the computing system using the second machine learning model, one or more playbooks based on said one or more clustered customer care conversations.

2. The computer-implemented method of claim 1, wherein the first machine learning model is a transformer encoder machine learning model, and/or wherein the second machine learning model is a transformer decoder machine learning model.

3. The computer-implemented method of claim 1, wherein the playbooks provide one or more of:
enforcement of brand-specific criteria,
enforcement of brand leadership and/or agent manager goal alignment, or
assurance of customer care conversation quality.

4. The computer-implemented method of claim 1, further comprising:
generating, by the computing system, a record of one or more conversation clusters to which said one or more generated playbooks correspond;
mapping, by the computing system using the first machine learning model, a new customer care conversation to a cluster; and
determining, by the computing system using the record, a playbook generated for said cluster to which the new customer care conversation has been mapped.

5. The computer-implemented method of claim 1, further comprising:
providing, by the computing system, to a further machine learning model, one or more customer care conversations and one or more playbooks; and
generating, by the computing system using the further machine learning model, one or more overlooked tasks.

6. The computer-implemented method of claim 1, further comprising:
providing, by the computing system, to a further machine learning model, one or more customer care conversations and one or more overlooked tasks; and
generating, by the computing system using the further machine learning model, one or more next task suggestions.

7. The computer-implemented method of claim 6, wherein the next task suggestions comprise one or more of nudges or stories.

8. The computer-implemented method of claim 1, further comprising:
providing, by the computing system, to a further machine learning model, one or more customer care conversations; and
generating, by the computing system using the further machine learning model, one or more knowledge base entries.

9. The computer-implemented method of claim 1, further comprising:
providing, by the computing system, to a further machine learning model, one or more customer care conversations; and
generating, by the computing system using the further machine learning model, one or more questions and answers.

10. The computer-implemented method of claim 1, further comprising:
providing, by the computing system to the second machine learning model as fine-tuning training inputs, one or more customer care conversations; and
providing, by the computing system to the second machine learning model as fine-tuning training outputs, one or more playbooks.

11. A system, comprising:
at least one processor; and
a memory storing instructions that, when executed by the at least one processor, cause the system to perform:
providing, to a first machine learning model, one or more customer care conversations;
mapping, using the first machine learning model, the one or more customer care conversations to one or more clusters;
providing, to a second machine learning model, said one or more clustered customer care conversations; and
generating, using the second machine learning model, one or more playbooks based on said one or more clustered customer care conversations.

12. The system of claim 11, wherein the instructions, when executed by the at least one processor, further cause the system to perform:
generating a record of one or more conversation clusters to which said one or more generated playbooks correspond;
mapping, using the first machine learning model, a new customer care conversation to a cluster; and
determining, using the record, a playbook generated for said cluster to which the new customer care conversation has been mapped.

13. The system of claim 11, wherein the instructions, when executed by the at least one processor, further cause the system to perform:
providing, to a further machine learning model, one or more customer care conversations and one or more playbooks; and
generating, using the further machine learning model, one or more overlooked tasks.

14. The system of claim 11, wherein the instructions, when executed by the at least one processor, further cause the system to perform:
providing, to a further machine learning model, one or more customer care conversations and one or more overlooked tasks; and
generating, using the further machine learning model, one or more next task suggestions.

15. The system of claim 11, wherein the instructions, when executed by the at least one processor, further cause the system to perform:
providing, to a further machine learning model, one or more customer care conversations; and
generating, using the further machine learning model, one or more knowledge base entries.

16. A non-transitory computer-readable storage medium including instructions that, when executed by at least one processor of a computing system, cause the computing system to perform a method, comprising:
providing, to a first machine learning model, one or more customer care conversations;
mapping, using the first machine learning model, the one or more customer care conversations to one or more clusters;
providing, to a second machine learning model, said one or more clustered customer care conversations; and
generating, using the second machine learning model, one or more playbooks based on said one or more clustered customer care conversations.

17. The non-transitory computer-readable storage medium of claim 16, wherein the instructions, when further executed by the at least one processor of the computing system, further cause the computing system to perform:
generating a record of one or more conversation clusters to which said one or more generated playbooks correspond;
mapping, using the first machine learning model, a new customer care conversation to a cluster; and
determining, using the record, a playbook generated for said cluster to which the new customer care conversation has been mapped.

18. The non-transitory computer-readable storage medium of claim 16, wherein the instructions, when further executed by the at least one processor of the computing system, further cause the computing system to perform:
providing, to a further machine learning model, one or more customer care conversations and one or more playbooks; and
generating, using the further machine learning model, one or more overlooked tasks.

19. The non-transitory computer-readable storage medium of claim 16, wherein the instructions, when further executed by the at least one processor of the computing system, further cause the computing system to perform:
providing, to a further machine learning model, one or more customer care conversations and one or more overlooked tasks; and
generating, using the further machine learning model, one or more next task suggestions.

20. The non-transitory computer-readable storage medium of claim 16, wherein the instructions, when further executed by the at least one processor of the computing system, further cause the computing system to perform:
providing, to a further machine learning model, one or more customer care conversations; and
generating, using the further machine learning model, one or more knowledge base entries.
